(19) United States
(12) Patent Application Publication
(10) Pub. No.: US 2003/0023329 A1
(43) Pub. Date: Jan. 30, 2003

(54) Method and apparatus to provide digital or analog audio signals to multiple computer system outputs

(76) Inventors: Robert Brooks JR., Houston, TX (US); Kenneth K. Sellers, Houston, TX (US)

Correspondence Address: CONLEY ROSE & TAYON, P.C., P. O. BOX 3267, HOUSTON, TX, 77253-3267, US

(21) Appl. No.: 09/912,604

(22) Filed: Jul. 24, 2001

(51) Int. Cl. G06F 17/00; H04R 29/00

(52) U.S. Cl. 700/94; 381/56

(57) ABSTRACT

An audio controller circuit to generate audible sounds for use on a computer system comprising a digital audio controller that generates digital audio signals reproducible by a digital audio device. The digital controller also operates in conjunction with a mixed-signal codec to generate analog audio signals reproducible by an analog audio device. The controller circuit is capable of delivering audio signals to a plurality of audio output connectors, each configured to accept a mating connector coupled to an external audio device. The audio controller circuit transmits audio signals to one output at a time. The circuit detects whether the external audio device coupled to an output connector is an analog or digital device and transmits the appropriate analog or digital audio signals to the output device.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to the transmission of audio signals from a computer system to external playback devices. More specifically, the preferred embodiment relates to the selectably switching between analog or digital audio signal transmission based on the type of playback device presently coupled to a computer system.

2. Background of the Invention

As personal home computers become more capable of delivering complex multimedia presentations, output devices such as the graphics and sound devices become a more integral part of the computer system. Flat-screen monitors and liquid crystal displays provide better image quality, resolution, and greater color depth than conventional CRT monitors. Sound systems are also becoming more complex. For instance, with the incorporation of digital encoding standards (e.g., Dolby AC-3), computers are capable of delivering audio signals to multiple external speakers to produce sound that rivals many home theatre systems.

Another advancement in the area of sound reproduction is the ability for computer systems to transmit digital audio signals to external speakers or headphones. Conventional computer systems, and audio systems in general, transmit analog audio signal via a two-wire cable that consists of positive and negative leads or wires. The negative lead is typically called the ground or reference wire whereas the positive lead is the signal carrier. In analog transmission, a source device transmits the audio signal as it should be played back, but connectors, wires, and other impedances along the transmission path introduce noise to the audio signal. Since playback speakers merely reproduce the signals that are delivered to them, analog speakers reproduce any noise that is added to the analog audio signal. Digital signal transmission is desirable because signal losses introduced by physical connections and wire transmission do not generally affect the quality of the reproduced sound. That is, digital playback devices (e.g., speakers, headphones) are generally capable of fully reconstructing the original, source audio despite signal degradation.

As digital playback devices become more readily available, computer systems are beginning to accommodate such devices. However, as with the advent of any new reproduction technology, manufacturers must still support legacy designs for as long as those legacy systems are readily available. In this particular case, manufacturers generally continue to provide analog speaker outputs because analog speakers and headphones are still, and will likely remain, the industry standard for years to come. As such, computer manufacturers are beginning to develop systems that can transmit both analog and digital audio signals to external playback devices.

To accommodate such computer systems, Creative Labs has created an audio controller that can sense whether analog or digital speakers are connected to a single audio output connector. The technique has been implemented by Creative Labs for use in computer sound cards and takes advantage of a characteristic difference between analog and digital audio transmission. In this solution, only one connector is needed for either analog or digital speakers. Thus, Creative Labs has created a user-friendly system that eliminates compatibility issues. That is, end-users do not need to worry about connecting digital speakers to an analog output and vice-versa. FIGS. 1A and 1B show simplified schematics of a conventional audio connector 10 suitable for use in such a system. FIG. 1A represents an analog configuration while FIG. 1B represents a digital equivalent. In each case, the signals on the left side of the connector 10 represent source signals from a computer system or sound card (not shown). These signals include a left channel signal (L), a right channel signal (R), and a ground connection (GND). In FIG. 1A, an analog speaker jack, which is not shown but may be a common tip-ring-sleeve or RCA jack, makes contact with the appropriate R, L, and GND contacts in connector 10 and transmits the signals via wires to the speakers or headphones. However, in a digital speaker system, a single channel is sufficient to transmit the digital signal to the playback device. The playback device converts the digital signal to analog for playback. Thus, in FIG. 1B, one channel is simply coupled to ground and the digital signal is transmitted on the remaining channel. Hence, the channel that is grounded during digital transmission may be referred to as the “grounded channel” regardless of whether digital or analog transmission occurs.

The auto-detection technique used by Creative Labs takes advantage of the fact that one of the two transmission channels needed for analog signal transmission is grounded by digital speakers. The method by which analog or digital speakers are detected is shown in FIG. 2. The simple audio signal transmission circuit shown in FIG. 2 includes an audio connector 10, an audio controller 12 and a codec 14. The audio controller 12 is capable of transmitting either analog or digital signals to a connector 10 located at the rear of a computer system. In FIG. 2, digital signals are transmitted directly to the audio connector 10 although in practice, the signals may be filtered or otherwise processed before they are sent to the connector 10. For analog signals, the audio controller 12 first transmits digital information to a codec 14, which converts the digital stream to analog signals. The analog signals, which are then transmitted to connector 10, are preferably in stereo, consisting of left (L) and right (R) channels. As with the digital audio signals, the analog signals may be filtered prior to transmission to the audio connector.

The auto-detection process implemented by Creative Labs begins when a speaker jack is connected to the rear connector 10. When new speakers are connected to the connector 10, the audio controller 12 on the sound card receives an interrupt indicating that a new speaker is present. The interrupt may be generated by logic circuitry or a simple contact (not shown) that senses when a speaker jack is physically coupled to connector 10. In response to the interrupt, the controller transmits a digital signal to the codec 14, which is then converted to a monaural, 24 KHz, analog test tone. The 24 KHz frequency is beyond the upper audible range for humans (20 KHz) and also beyond the frequency response of most speakers so the test tone is likely never actually heard by a computer user. This test tone is transmitted from the codec 14 to the speaker connector 10. More specifically, the test tone is transmitted on the right channel (R). As shown in FIG. 2, the right channel is tapped and the 24 KHz test tone, delivered to the speakers via connector 10 on the right channel, is transmitted back to a microphone input in the codec 14. As explained below, the value of the detection signal received by the codec 14 indicates the type of speaker (analog or digital) attached to the connector 10.

As shown in FIG. 1B, the digital speaker grounds the right channel. Consequently, if digital speakers are attached to connector 10 when the test tone is transmitted, the test tone will be attenuated because the channel is grounded. The codec 14 will therefore not detect the test tone. If, on the other hand, analog speakers (which do not ground the right channel) are attached to connector 10, the test tone will not be attenuated and codec 14 will detect the test tone. As such, whether the codec 14 detects the test tone indicates which type of speaker is present. If the 24 KHz test signal is detected, then analog speakers are present. Conversely, if the test signal is not detected, then digital speakers are present. Based on determining the speaker type, the codec 14 commands the audio controller 12 to transmit the appropriate signal type to the speaker output.

The configuration just described allows computer users to connect either analog or digital speakers to a single speaker output connector that is typically located at the rear of a computer system. Most modem computer systems, however, have multiple audio output connectors. For example, many computer systems also have a headphone connector located at the front of the computer system. Unfortunately, the above described auto-detection circuitry does not account for multiple audio output connectors. The auto-detection technique is limited to checking the speaker type for the connector at the rear of a computer system. This problem limits the types of headphones or speakers that can be connected to other outputs.

Perhaps more significant is the fact that the conventional auto-detection system described above does not allow playback devices of mixed types to be connected to a computer system. This problem arises because conventional audio controllers output a single signal type (analog or digital) that is forwarded to all designated outputs. For example, if the computer system detects digital speakers at the rear of the computer, the audio controller will deliver digital signals to the front and rear output connectors. Thus, analog headphones connected to the front of the computer will not work. Similarly, if analog speakers are connected at the rear of the computer, then digital speakers or headphones connected to the front of the computer will not work. Some conventional systems partially solve this problem by routing analog audio to the front audio connector full time. Unfortunately, this solution means that digital playback devices plugged into the front of the computer system will never work.

It is desirable therefore, to develop a computer system that detects a playback device type (digital or analog) at a plurality of audio output connectors. The auto-detection circuitry would advantageously allow users to listen to computer audio signals using either analog or digital speakers or headphones connected to any of the output connectors.

### BRIEF SUMMARY OF THE INVENTION

The problems noted above are solved in large part by an audio controller circuit configured to generate audible sounds for use on a computer system. The audio controller circuit comprises a digital audio controller, a mixed-signal codec, a programmable logic device, a plurality of audio output connectors, an analog output muter, a digital output switch, and a detection switch. The digital audio controller is configured to generate digital audio signals reproducible by a digital audio device. The mixed-signal codec is configured to communicate with the digital audio controller and to generate analog audio signals reproducible by an analog audio device. Each of the audio output connectors is configured to accept a mating connector coupled to an external audio device. The analog output muter is configured to selectably transmit analog audio signals received from the codec to the output connectors while the digital output switch is configured to selectably transmit digital audio signals to the same output connectors. Lastly, the detection switch is configured to selectably transmit detection signals from the output connectors back to the codec.

The audio controller circuit is configured to detect whether an external audio device coupled to an output connector is an analog or digital device and is also capable of transmitting either analog or digital audio signals to any of the output connectors. The audio controller circuit also has an internal analog output that is used to transmit analog audio signals to an internal computer speaker if none of the output connectors are coupled to external audio devices.

The output connectors preferably consist of a front output connector and a rear output connector. If the front output connector is coupled to an external audio device, the audio controller circuit asserts a Line Out mute signal to mute the rear output connector and also asserts a Speaker mute signal to mute the internal analog output. Similarly, if the front output connector is not coupled to an external audio device, but the rear output connector is coupled to an external audio device, the audio controller circuit asserts the same Speaker mute signal. If no external speakers are attached to the system, neither of the mute signals are asserted.

The digital output switch transmits digital audio signals to the front output connector when the Line Out mute signal is asserted and transmits digital audio signals to the rear output connector when the Line Out mute signal is de-asserted. Similarly, the analog output muter uses these mute signals to selectably mute or transmit analog audio signals to the audio outputs. If the Line Out mute signal is asserted, the muter does not transmit analog audio signals to the rear output connector. If the Speaker mute signal is asserted, the muter does not transmit analog audio signals to the internal analog output. The detection switch also operates in response to the Line Out mute signal. The detection switch transmits test-tone detection signals from the front output connector back to the codec when the Line Out mute signal is asserted and transmits detection signals from the rear output connector back to the codec when the Line Out mute signal is de-asserted.

The programmable logic device is configured to transmit an interrupt that instructs the digital audio controller and codec to transmit an analog test tone to the muter, which then forwards the test tone to the appropriate output as determined by the mute signals. The programmable logic device transmits the interrupt when the value of either the Line Out mute signal or the Speaker mute signal changes. The detection switch routes the test-tone detection signals back from the appropriate output (as determined by the Line Out mute signal). If the codec detects the test-tone, the audio controller circuit transmits analog audio signals. Conversely, if the codec does not receive a detection signal, the audio controller circuit transmits digital audio signals. The audio signals are then routed to the appropriate output by the analog output muter or digital output switch for transmission to the appropriate output connector.

### BRIEF DESCRIPTION OF THE DRAWINGS

For a detailed description of the preferred embodiments of the invention, reference will now be made to the accompanying drawings in which:

FIG. 1 shows a conventional audio connector configured to accept a jack to transmit either analog or digital audio signals to a playback device;

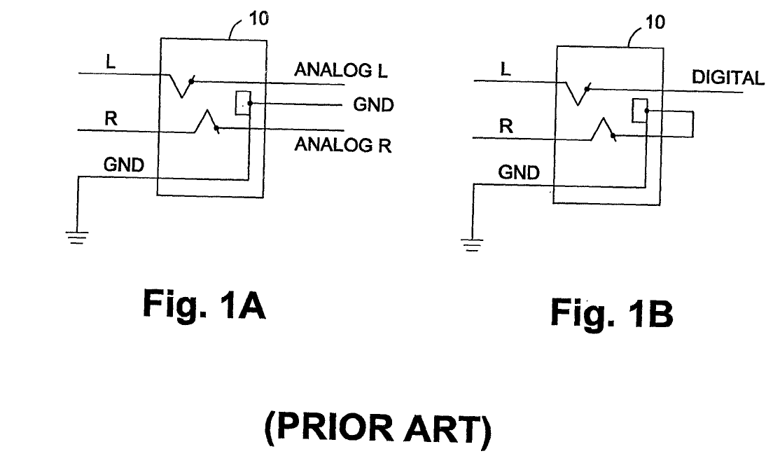

FIG. 2 shows a prior art circuit for automatically detecting whether an analog or digital playback device is coupled to the audio connector of FIG. 1;

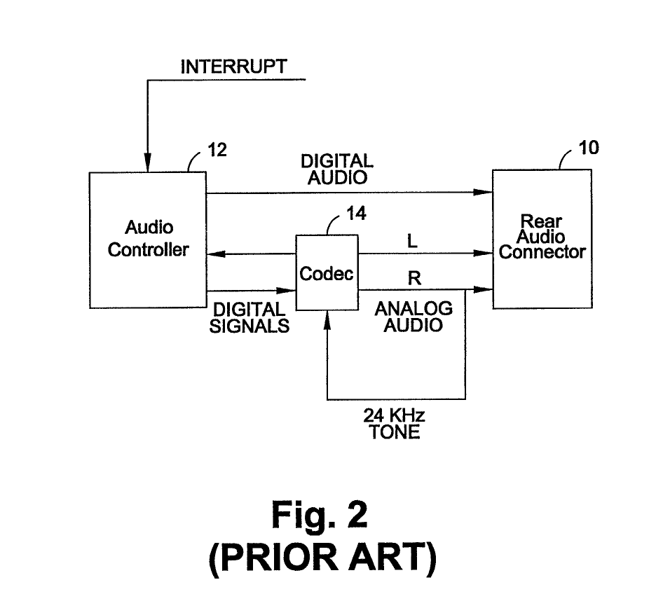

FIG. 3 shows a simple computer system in which the preferred embodiment may be implemented;

FIG. 4 shows a block diagram of the computer system of FIG. 3 in which the preferred embodiment may be implemented;

FIGS. 5A and 5B show the preferred and alternative state diagrams, which dictate where audio signals are transmitted and which speakers are muted based on how external speakers are coupled to the computer system;

FIG. 6 shows a preferred embodiment of the audio playback type/location detection circuitry; and

FIG. 7 shows a state diagram indicating the preferred implementation of the speaker interrupt signal as implemented in the preferred embodiment.

### Notation and Nomenclature

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. Furthermore, the term “playback device” is intended to refer to any type of sound generation device such as speakers, headphones, or piezoelectric or electromagnetic transducers that convert electrical signals from a computer system to audible sounds.

### DETAILED DESCRIPTION OF THE PREFERRED EMBODIMENTS

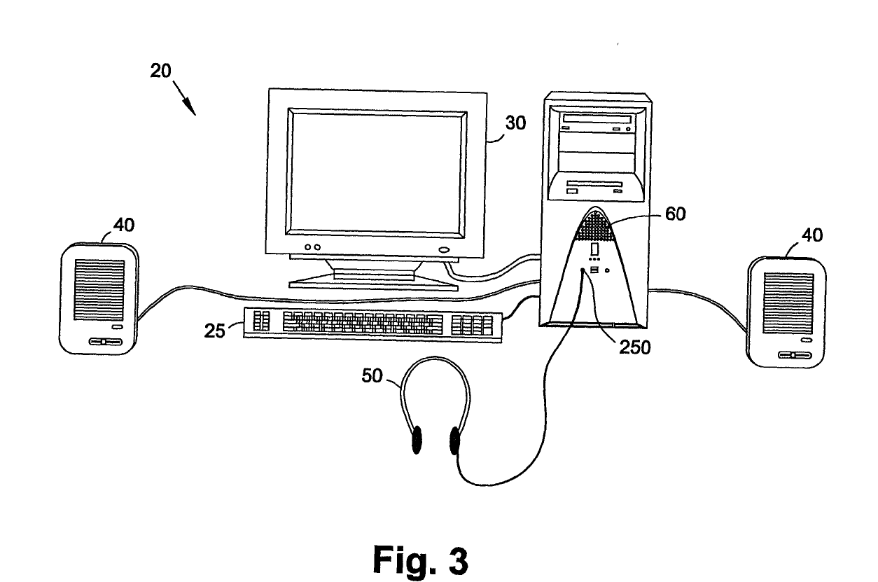

Turning now to the figures, FIG. 3 shows an example of a desktop computer system 20 comprising a keyboard input device 25 and a video monitor output device 30. Other peripheral input or output devices such as a mouse, scanner, or printer may be coupled to the computer system 20, but are not specifically shown in FIG. 3. Computer system 20 is capable of producing audible sounds via a number of different audio outputs including a Line Out connector (not shown in FIG. 3) at the rear of the computer system 20 and a Headphone connector 250 at the front of the computer system 20. FIG. 3 also shows a pair of external speakers 40 that are preferably connected to the Line Out connector. Additionally, a headphone set 50 may be connected to the front audio connector 250 of computer system 20. In accordance with the preferred embodiment, each audio output is capable of providing either analog or digital audio signals to an external audio playback device such as external speakers 40 or headphone set 50. Thus, speakers 40 and headphones 50 may each be analog or digital devices. That is, speakers 40 can be digital while headphones 50 are analog or vice versa. In addition, as with many conventional computer systems, computer system 20 also includes an internal speaker 60 that resides inside the chassis of computer system 20. The internal speaker 60 plays sounds when external speakers 40 or headphones 50 are not connected to the system.

The configuration shown in FIG. 3 is not intended to limit the possible uses for the front and rear audio connectors. For instance, speakers may be connected to the front connector or headphones may be connected to the rear of the computer 20. The description herein is not intended to limit the various configurations. In addition, while cabled devices 40, 50 are shown in FIG. 3, it is also feasible that wireless playback speakers or headphones may also be used with the preferred embodiment. Also, the external speakers 40 may be physically attached to the monitor 30 or the chassis of the computer system 20.

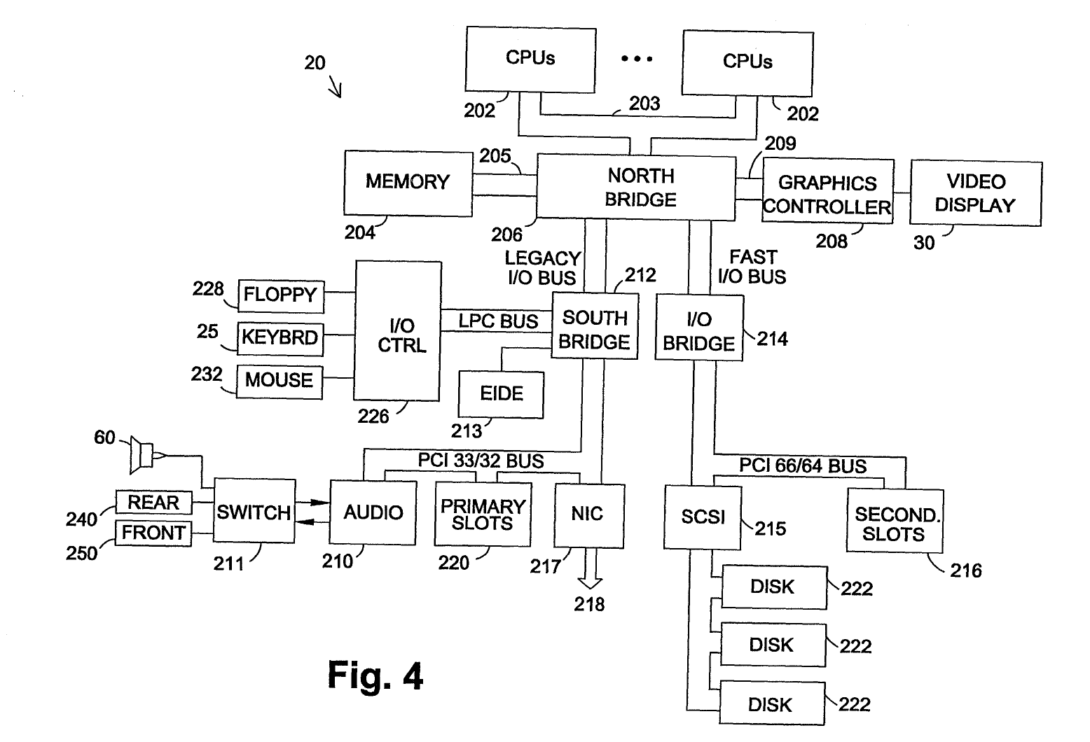

Referring now to FIG. 4, a representative computer system is illustrated in which the preferred embodiment may be implemented. It is noted that many other representative configurations exist and that this embodiment is described for illustrative purposes. The computer system 20 of FIG. 4 preferably includes multiple CPUs 202 coupled to a bridge logic device 206 via a CPU bus 203. The bridge logic device 206 is sometimes referred to as a “North bridge” for no other reason than it often is depicted at the upper end of a computer system drawing. The North bridge 206 also preferably comprises a memory controller to access and control a main memory array 204 via a memory bus 205 and may further couple to a graphics controller 208 via an accelerated graphics port (AGP) bus 209. The graphics controller 208 drives the video display 30. The North bridge 206 couples CPU 202, memory 204, and graphics controller 208 to each other and to various peripheral devices in the system via one or more high-speed, narrow, source-synchronous expansion buses such as a Fast I/O bus and a Legacy I/O bus. The North bridge 206 can couple additional “high-speed narrow” bus links other than those shown in FIG. 4 to attach other bridge devices and other buses such as a PCI-X bus segment to which additional peripherals such as a 1 Gigabit Ethernet adapter may be coupled. The embodiment shown in FIG. 4 is not intended to limit the scope of possible computer architectures.

The Fast I/O bus shown in FIG. 4 may link the North bridge 206 and an I/O bridge 214 that provides access to a high-speed 66 Mhz, 64-bit PCI bus segment. A SCSI controller 215 may reside on this high speed PCI bus and manages multiple fixed disk drives 222. In the alternative, the disk drive controller 215 and internal drives 222 may also be coupled to the primary 32-bit 33 Mhz PCI bus. The high speed PCI bus also provides secondary expansion slots 216 that permit coupling of peripheral devices that comply with the high speed PCI bus.

The Legacy I/O bus is preferably used to connect legacy peripherals and a primary PCI bus via a separate bridge logic device 212. This bridge logic 212 is sometimes referred to as a “South bridge” reflecting its location vis-a-vis the North bridge 206 in a typical computer system drawing. An example of such bridge logic is described in U.S. Pat. No. 5,634,073, assigned to Compaq Computer Corporation. The South bridge 212 may provide access to an EIDE controller 213 for connection to a CD-ROM device (not shown) and provides a low-pin count (“LPC”) bus to legacy peripherals coupled to an I/O controller 226. The I/O controller 226 typically interfaces to basic input/output devices such as a floppy disk drive 228, a keyboard 25, a mouse 232 and, if desired, various other interfaces such as parallel or serial data ports (not shown). The South bridge 212 also may provide one or more expansion buses, but preferably provides a 32-bit 33 Mhz PCI bus segment on which various devices are disposed.

Various components that comply with the bus protocol of the 33 Mhz, 32-bit PCI bus may reside on this bus, such as an audio controller 210 and a network interface card (“NIC”) 217. The NIC 217 preferably comprises an ethernet controller and is coupled to a network 218 for communication with other computers. In the preferred embodiment, audio controller 210 and other circuitry related to the preferred embodiment may be installed on the computer's motherboard as presumed by FIG. 4. However, it should be recognized that the logic and components herein may be provided on an expansion card or even external to the computer 20 or on the speakers 40 themselves.

Most or all sounds played by computer 20 are preferably generated by the audio controller 210 and reproduced via any of a variety of playback devices such as an internal speaker 60, external speakers 40, or external headphones 50. In accordance with the preferred embodiment, the audio controller 210 preferably transmits audio signals to switching circuitry 211. The switching circuitry 211 comprises logic that selectably forwards the audio signals to only one playback device at a given time. The switching circuitry 211 also allows detection signals that are used to determine which type of speakers are connected to the system to be routed from the external devices back to the audio controller 210. A more detailed description of the switching circuitry 211 is provided below. External speakers 40 or external headphones 50 may be connected to the computer 20 via audio connectors that receives audio signals from the switching circuitry 211. Computer system 20 preferably includes at least a rear connector 240 located at the rear of the computer and a front connector 250 located at the front of the computer. In the event connectors 240, 250 are not used to transmit audio to external playback devices, switching circuitry 211 defaults to internal speaker 60 for sound reproduction.

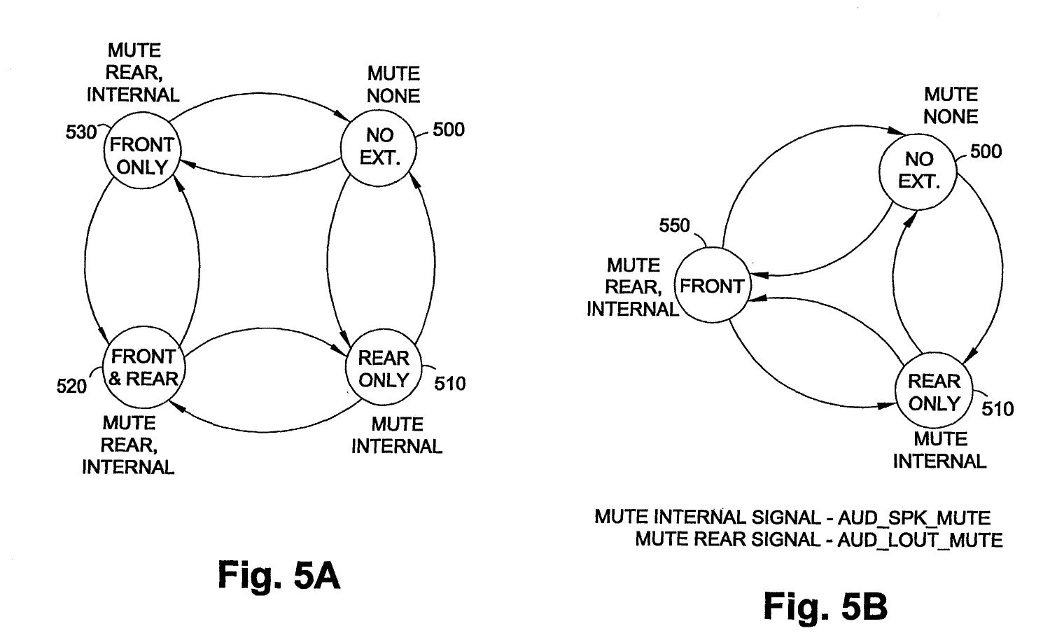

As mentioned above, computer system 20 transmits audio signals to a single playback device at a given time. The playback devices are prioritized and only the highest priority device connected to the computer system 20 is used for reproducing sounds. All subordinate devices are muted. The state diagram shown in FIG. 5A and the alternative embodiment in FIG. 5B represent the prioritization of the playback devices and indicates which devices are muted under various situations. For example, in FIG. 5A, state 500 represents the condition where no external playback devices are connected to the computer 20. In this situation, the internal speaker 60 is not muted and is allowed to play audible sounds. In fact, none of the audio signals are muted because it is assumed that there are no external devices plugged into the computer to reproduce audio signals.

If external speakers 40 are connected only to the rear connector 240 of computer 20, as indicated by state 510, then playback priority is given to the external speakers 40 and the internal speaker 60 is muted. This is done because it is generally assumed that external speakers 40 provide better fidelity and frequency response and should therefore be used for audible sounds instead of the internal speaker 60.

If both the front 250 and rear 240 connectors are used, as designated by state 520, then playback priority is given to the front speakers/headphones and the computer 20 mutes the rear and internal speaker signals. The front speaker connector 250 is typically used for headphones 50. Consequently, the other audio signals are muted for privacy. Similarly, if the rear connector 240 is not used and speakers or headphones are connected only to the front audio connector 250 (state 530), the same muting is employed. Hence, because the muting is the same for states 520 and 530, these states may be collapsed into a single state 550 as shown in FIG. 5B. FIG. 5B accurately reflects the possible combinations of sound reproduction for computer 20. In short, if no external devices are present (500), the internal speaker is used. If only the rear connector 240 is used (510), the rear speakers are used. Lastly, if the front connector 250 is used (550), then the front speakers are used, regardless of whether any device is connected to the rear connector 240.

According to the preferred embodiment, speaker signals are muted by two mute commands that change value according to the state diagram of FIG. 5B. These two commands are labeled AUD_LOUT_MUTE and AUD_SPK_MUTE. The former controls the Line Out signals that are transmitted to the rear connector 240 of computer 20 while the latter controls the internal speaker 60 in computer 20. These commands are preferably binary signals with one state indicating that the signals traveling to the respective destinations should be muted while the alternative state indicates that the signals should be transmitted. Polarity of the signals is irrelevant, but in the preferred embodiment, a MUTE signal asserted high indicates that the audio signals are in fact muted. The MUTE commands may be generated by a state machine, a logic circuit, embedded code, or any of a variety of methods that are dependent upon whether a physical contact is present at the output connectors 240, 250. For example, the AUD_LOUT_MUTE command is asserted when a jack is actually inserted into the front connectors 250. Similarly, the AUD_SPK_MUTE command is asserted when a jack is inserted into either the rear connector 240 or the front connector 250.

One other point that may not be readily apparent from the state diagrams in FIGS. 5A and 5B must be noted. The audio outputs are preferably prioritized and all but the highest priority output is assigned a MUTE signal. Thus, the internal speaker 60 is controlled by the AUD_SPK_MUTE command while the rear connector 240 is controlled by the AUD_LOUT_MUTE command. As a general rule, for any audio output, if the higher priority output(s) is/are not in use, then the use of that output will cause the MUTE signals for all lower priority outputs to be asserted. This prioritization scheme is therefore expandable to more outputs than are presented in the preferred embodiment.

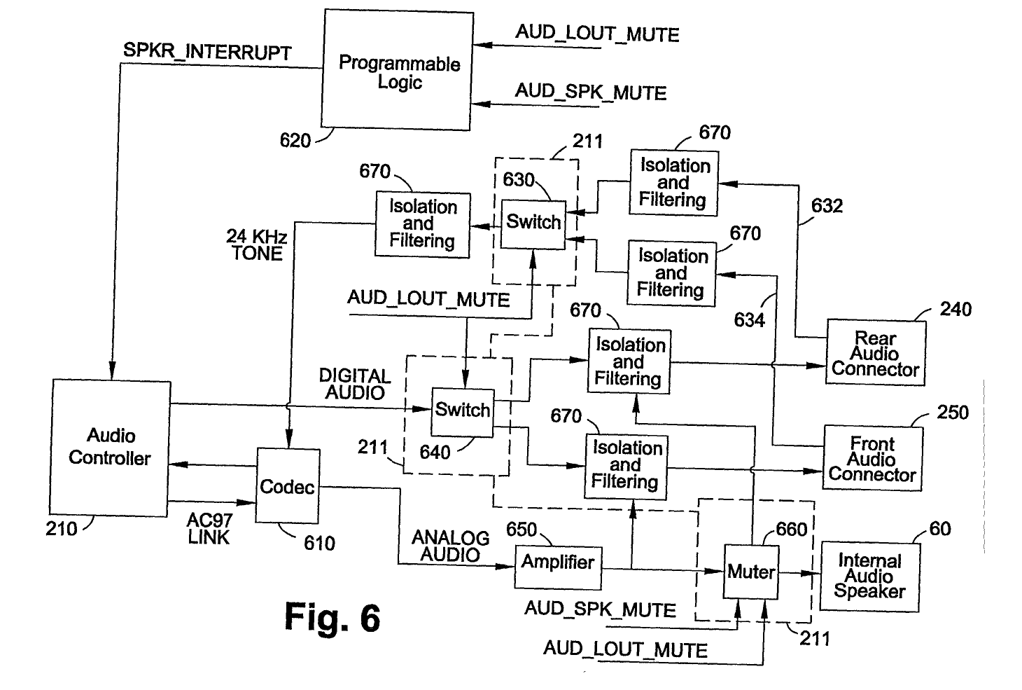

Referring now to FIG. 6, the AUD_LOUT_MUTE and AUD_SPK_MUTE signals described above are used in accordance with the preferred embodiment to allow an audio controller to determine whether analog or digital playback devices are coupled to either the front or rear output connectors 240, 250. A preferred embodiment of a circuit that permits this functionality is shown in FIG. 6. The circuit in FIG. 6 includes, among other components, the audio controller 210, switching circuitry 211, internal speaker 60, and front and rear audio connectors 250, 240 that are shown in FIG. 4 and discussed above. These connectors are preferably industry standard 1/8 inch, female, tip-ring-sleeve (TRS) connectors, but my also be implemented as ¼ inch TRS connectors, RCA connectors, or other suitable connectors. The circuit in FIG. 6 also includes a mixed-signal audio Codec device 610, a programmable logic device 620, and an amplifier 650. Switches 630, 640, and a muting device 660 are components in the switching circuitry 211 described above. FIG. 6 also includes isolation and filtering circuitry 670 in various locations for filtering, noise reduction, or signal conditioning of analog audio signals.

The audio controller 210 is preferably a digital controller and is coupled to other components in computer 20 via a PCI bus although the controller 210 may alternatively be integrated into a computer system core logic chipset. The preferred embodiment uses a SoundBlaster audio controller 210 from Creative Labs, which is responsible for generating digital audio signals for transmission to digital audio devices. The digital audio signals preferably conform to the Sony/Phillip Digital Interface (S/PDIF) and may be transmitted to external digital playback or storage devices via the front or rear audio connectors 250, 240. The position of switch 640, which is controlled by the AUD_LOUT_MUTE signal discussed above, determines whether the digital audio signals are transmitted to the front connector 250 or rear connector 240. If the AUD_LOUT_MUTE signal is asserted indicating that the front connector 250 is in use, then the switch routs the digital signals to the front audio connector 250. Conversely, if the AUD_LOUT_MUTE signal is de-asserted, the switch routs the digital signals to the rear connector 240.

The audio controller 210 also generates analog signals with the aid of Codec 610. The audio controller 210 and Codec 610 preferably communicate via a serial data link that complies with the AC '97 Audio Specification. This specification, published by Intel and entitled “Audio Codec '97 Component Specification,” defines the architecture and digital interface (AC-Link) for I/O functionality related to computer systems and audio playback devices. The latest version of the specification is Revision 2.2 and is hereby incorporated herein by reference. Codec 610 preferably receives AC'97 compliant data from the audio controller 210 and converts the digital information to analog audio that may be reproduced by external playback devices. Analog audio signals generated by Codec 610 are first amplified to usable levels by amplifier 650. A muter device 660 selectably transmits or disables analog audio signal transmission to the internal speaker 60 and/or rear audio connector 240 based on the values of AUD_SPK_MUTE and AUD_LOUT_MUTE signals. If the AUD_SPK_MUTE signal is de-asserted, indicating that no external playback devices are attached to the computer, then muter 660 allows the analog signals to reach the internal speaker. If AUD_SPK_MUTE is asserted, muter 660 blocks the analog signals from reaching the internal speaker, thereby effectively muting said speaker.

Similarly, if the AUD_LOUT_MUTE signal is asserted, indicating that the front connector 250 is in use, muter 660 blocks the analog signals from reaching the rear connector 240 to mute any devices that may be attached to that connector. Otherwise, if the front connector 250 is not in use, muter 660 allows the analog signals from amplifier 650 to reach the rear connector 240, regardless of whether that connector is in use. The reason for transmitting analog signals to the rear connector 240 even in the absence of any external speakers connected to that connector is explained below. It should be noted that in the preferred embodiment, the front audio connector 250 is never muted because this connector has priority over the remaining audio outputs.

As discussed above, the SoundBlaster audio controller is capable of distinguishing between digital and analog playback devices located at a single audio output by determining whether a 24 KHz test tone sent to a device at the output is received back at the Codec 610. The test tone is transmitted in response to an interrupt that is generated when a new playback device is coupled to the computer. However, in conventional systems, this feature was limited to a single output connector. In the preferred embodiment, the digital/analog auto-detection feature is extended to multiple outputs by coupling each output connector 240, 250 to the Codec 610 via switches that change position depending on the AUD_LOUT_MUTE signal. In addition to muter 660, the circuit shown in FIG. 6 includes two switches: one placed in the digital output path 640 and another in the test-tone return path 630. The muter 660 determines which of three audio outputs receive analog signals from Codec 610. The output path switch 640 selectably transmits digital S/PDIF audio signals to either the front or rear output connectors 250, 240. The second switch 630 controls which one of two return signals 632, 634 reaches Codec 610. This switch 630 is preferably controlled by the same AUD_LOUT_MUTE signal that controls the position of output switch 640. Thus, if a set of speakers or headphones are connected to the front connector 250, switch 630 connects the front connector 250 via return path 634 to Codec 610. If the front connector 250 is not in use, switch 630 connects the rear connector 240 via return path 632 to Codec 610.

Consequently, muter device 660 and switch 630 create an analog signal loop between the Codec 610 and the appropriate output connector 240, 250. As such, when the Codec 610 issues the 24 KHz test tone to check for speaker-type, the signal travels from the Codec 610, through amplifier 650, to the front audio connector 250. The test-tone reaches the rear audio connector 240 only if allowed by muter 660 (i.e., when the front connector 250 is not in use). As with a conventional system, this test-tone is transmitted on only one of two stereo channels to detect whether that channel is grounded by a digital playback device. If the front connector 250 is used, the test-tone may return (if an analog speaker is present) along path 634, through switch 630 and back to an appropriate microphone input in Codec 610. If the front connector 250 is not used, the test-tone may return along path 632, through switch 630 and back to Codec 610. Note also, that if no external speakers are used, the test-tone will still reach the rear connector 240 and return to Codec 610 along the path just described. Unless there is a digital speaker coupled to connector 240, the channel on which the test-tone is transmitted is not grounded. Thus, even if there is no speaker jack plugged into connector 240, the test-tone will still reach Codec 610 along the return path 632. Codec 610 will in turn, issue a command to controller 210 that analog speakers are present and the computer system 20 will therefore play analog sounds through the internal speaker. Similarly, as with the conventional system, if the Codec 610 does not receive the test-tone at the microphone input, this indicates that a digital playback device is present and the controller will transmit S/PDIF signals to the appropriate output connector 240, 250 via switch 640.

As those skilled in the art will recognize, the switch devices 630, 640 and muter device 660 may be implemented using a variety of solutions, including but not limited to TTL logic, multiplexers, tri-state buffers or any other devices that successfully carry out the functionality described herein.

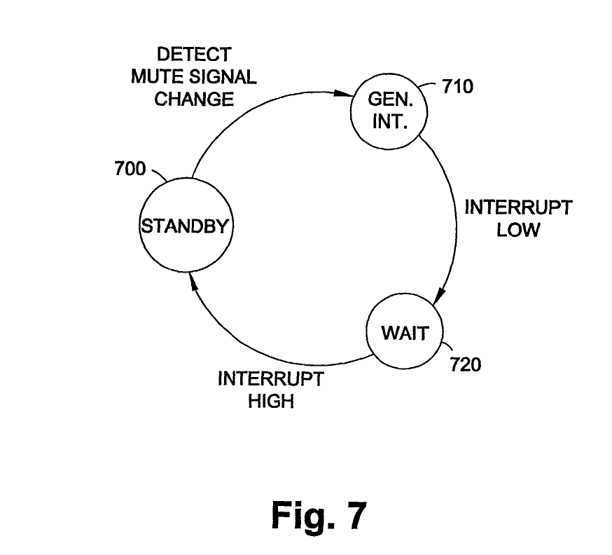

Referring still to FIG. 6, since audio controller 210 is capable of delivering either S/PDIF digital audio or AC '97 digital data for conversion to analog audio, the controller 210 must know when to deliver the appropriate data. As with the conventional approach, the preferred audio controller 210 receives an interrupt indicating that a test tone must be transmitted to the playback device to determine whether that playback device is analog or digital. In the conventional system, the interrupt is generated when a headphone or speaker jack is inserted into the Line Out jack. However, in this preferred embodiment, multiple jacks are monitored by the programmable logic device 620 to determine when it is appropriate to generate the interrupt. The programmable logic device 620 is configured to toggle the SPKR_INTERRUPT signal according to the state diagram shown in FIG. 7.

As FIG. 7 shows, the programmable logic device 620 normally operates in a standby mode 700. During standby 700, the output signal SPKR_INTERRUPT is asserted. According to the preferred embodiment, if either the AUD_LOUT_MUTE signal or the AUD_SPK_MUTE signal changes value, the programmable logic device 620 toggles the interrupt signal (i.e., de-asserts SPKR_INTERRUPT) 710 and waits for a predetermined amount of time 720 before restoring the SPKR_INTERRUPT signal to its normally high value. In the preferred embodiment, this wait time is nominally 500 microseconds and is sufficient to generate a pulse that the audio controller 210 recognizes as a command to generate the test-tone. The programmable logic device 620 is preferably implemented as a programmable array logic (PAL) device, although other solutions including a programmable gate array (PGA) or other logic gates may suffice.

The preferred embodiment, as disclosed herein, may advantageously simplify computer manufacturing methods by allowing a single motherboard (which implements the preferred embodiment) to be assembled across a variety of platforms. Such platforms may be offered or sold with analog or digital speaker and headphone options.

The above discussion is meant to be illustrative of the principles and various embodiments of the present invention. Numerous variations and modifications will become apparent to those skilled in the art once the above disclosure is fully appreciated. For example, the preferred embodiment is limited to two outputs. It is entirely possible to extend the teachings herein to a system involving more audio outputs by adding appropriate switches and logic. It is also feasible that the preferred embodiment may be extended to a system that plays music to multiple outputs provided the audio controller is capable of transmitting analog and digital signals simultaneously. It is intended that the following claims be interpreted to embrace all such variations and modifications.

What is claimed is:

1. A computer system, comprising:
a processor;
a system memory coupled to said processor;
at least one input/output device coupled to said processor;
an internal audio speaker device; and
an audio controller circuit that transmits digital audio signals or analog audio signals to the internal audio speaker or to external audio playback devices coupled to the computer via a plurality of output connectors;
wherein the audio controller circuit determines whether each device is analog or digital for the purpose of transmitting corresponding analog or digital audio signals to each device.

2. The computer system of claim 1 wherein:
audible sounds are transmitted to and reproduced by one playback device at a time; and
wherein the audio controller circuit detects the device type for that one playback device and transmit analog or digital signals as required for that device.

3. The computer system of claim 1 further comprising:
a front audio connector; and
a rear audio connector;
wherein audio signals are transmitted by the audio controller circuit for playback by one of either the internal speaker device or a playback device coupled to the rear connector or a playback device coupled to the front audio connector.

4. The computer system of claim 3 wherein:
playback devices coupled to the rear connector have playback priority over the internal speaker device; and
playback devices coupled to the front connector have playback priority over playback devices coupled to the rear connector and the internal speaker device.

5. The computer system of claim 4 wherein the audio controller circuit determines whether to transmit analog or digital signals under the following conditions:
a) when a playback device is coupled to or removed from the front connector; and
b) when no playback device is coupled to the front connector and a playback device is coupled to or removed from the rear connector.

6. The computer system of claim 5 wherein:
if no external playback device is coupled to the computer system, the audio controller circuit transmits analog audio signals for playback by the internal speaker device.

7. An audio controller circuit that generates audible sounds for use on a computer system comprising:
a digital audio controller that generates digital audio signals reproducible by a digital audio device;
a mixed-signal codec that communicates with the digital audio controller and generates analog audio signals reproducible by an analog audio device;
a programmable logic device;
a plurality of audio output connectors, each configured to accept a mating connector coupled to an external audio device; and
a switching circuitry;
wherein the audio controller circuit detects whether an external audio device coupled to an output connector is an analog or digital device and transmit either analog or digital audio signals to any of the output connectors.

8. The audio controller circuit of claim 7 further comprising:
an internal analog output that transmits analog audio signals to an internal computer speaker if none of the output connectors are coupled to audio devices.

9. The audio controller circuit of claim 8 wherein the output connectors comprise:
a front output connector; and
a rear output connector;
wherein if the front output connector is coupled to an external audio device, the audio controller circuit:
asserts a first mute signal to mute the rear output connector; and
asserts a second mute signal to mute the internal analog output; and
wherein if the front output connector is not coupled to an external audio device and the rear output connector is coupled to an external audio device, the audio controller circuit:
asserts the second mute signal to mute the internal analog output.

10. The audio controller circuit of claim 9 wherein the switching circuit further comprises a digital output switch that:
transmits digital audio signals to the front output connector when the first mute signal is asserted; and
transmits digital audio signals to the rear output connector when the first mute signal is de-asserted.

11. The audio controller circuit of claim 9 wherein the switching circuit further comprises analog output muter that uses the first and second mute signals to selectably mute or transmit analog audio signals to the outputs such that:
if the first mute signal is asserted, the muter does not transmit analog audio signals to the rear output connector; and
if the second mute signal is asserted, the muter does not transmit analog audio signals to the internal analog output.

12. The audio controller circuit of claim 11 wherein the switching circuit further comprises a detection switch that:
transmits detection signals from the front output connector to the codec when the first mute signal is asserted; and transmits detection signals from the rear output connector to the codec when the first mute signal is de-asserted.

13. The audio controller circuit of claim 12 wherein:
the programmable logic device transmits an interrupt that instructs the digital audio controller and codec to transmit an analog test tone to the muter when the value of either the first mute signal or the second mute signal changes.

14. The audio controller circuit of claim 13 wherein:
if the codec receives a detection signal, the audio controller circuit transmits analog audio signals; and
if the codec does not receive a detection signal, the audio controller circuit transmits digital audio signals.

15. A method of transmitting analog or digital audio signals to one of a plurality of computer system audio outputs comprising:
ranking the audio outputs in terms of playback priority;
transmitting audio signals from an audio controller circuit to the highest priority audio output to which an audio device is coupled;
wherein:
if a playback device is removed from the audio output to which audio signals are currently being transmitted; or
if a playback device is plugged into a higher priority output;
determining the device type for the audio device coupled to the highest priority audio output and transmitting the appropriate analog or digital audio signals to that output.

16. The method of claim 15 further comprising:
generating an interrupt to indicate to the computer system that a device type must be determined.

17. The method of claim 16 the process of determining the device type further comprises:
transmitting an analog test-tone to the highest priority output device; and
detecting whether the analog test tone is grounded by the output device;
wherein if the test tone is grounded, the device is a digital device and wherein if the test tone is detected, the device is an analog device.

18. The method of claim 17 wherein the test tone is transmitted to the right channel of a stereo output device.

19. The method of claim 17 wherein the audio signals and test tone are directed to and from the highest priority output device using switches.

20. The method of claim 16 wherein the interrupt is generated by a programmable logic device and the duration of the interrupt is 500 microseconds.
